(19) United States
(12) Patent Application Publication
(10) Pub. No.: US 2009/0060110 A1
(43) Pub. Date: Mar. 5, 2009

(54) Device and method for shutting off an orifice of a bundle wrapper of a steam generator of a pressurized-water nuclear reactor

(75) Inventors: Olivier Theallier, Saint Pierre De Varennes (FR); Jacques Catinot, Crissey (FR); Eric Dubois, Antully (FR)

Correspondence Address: CONNOLLY BOVE LODGE & HUTZ LLP, 1875 EYE STREET, N.W., SUITE 1100, WASHINGTON, DC, 20006, US

(73) Assignee: AREVA NP, Courbevoie (FR)

(21) Appl. No.: 12/108,193

(22) Filed: Apr. 23, 2008

(30) Foreign Application Priority Data
Apr. 24, 2007 (FR) 07 54664

(51) Int. Cl. G21C 13/00

(52) U.S. Cl. 376/203

(57) ABSTRACT

The invention relates to a device (20) for shutting off an inner orifice of a bundle wrapper of a steam generator comprising a movable shaft (21) comprising a pair of lower half-flanges (25, 26), a pair of upper half-flanges (27, 28) which can be rotated by the said shaft (21) substantially through 180° between a low position facing the lower half-flanges (25, 26), for introduction into the orifices of the casing and the wrapper of the steam generator, and a high position opposite the said lower half-flanges (25, 26), and means (22) for clamping the lower half-flanges (25, 26) and the upper half-flanges (27, 28) on the peripheries arranged on either side of the inner orifice, in order to shut off this inner orifice.

The invention also relates to a shutting-off method and to a tooling for installing and removing the shut-off device.

The present invention relates to a device and a method for shutting off an orifice of a bundle wrapper of a steam generator of a pressurized-water nuclear reactor.

The invention also relates to tooling for installing or removing such a shut-off device.

Pressurized-water nuclear reactors comprise steam generators which ensure the heating and evaporation of feedwater by the heat transported by the pressurized water for cooling the core of the reactor. Pressurized-water reactors comprise, on each of their primary branches, a steam generator having a primary part, in which the pressurized cooling water of the reactor circulates, and a secondary part, receiving feedwater which is progressively heated and evaporated and emerges from the secondary part of the steam generator in the form of steam which is delivered to a turbine associated with the nuclear reactor, in order to drive of an alternator for generating electrical current.

Such steam generators comprise an outer casing, called a pressure casing, of general cylindrical shape, arranged with its axis vertical and secured to a substantially horizontal tube plate, the lower face or inlet face of which forms one wall of the water box feeding the steam generator with pressurized water forming the primary coolant.

The steam generator likewise comprises a bundle of tubes bent in a U, each comprising two straight branches parallel to one another, the ends of which are fastened in holes passing through the tube plate between the lower inlet face of the tube plate and the upper outlet face via which the tubes of the bundle penetrate into the secondary part of the steam generator, in which an inner casing, called a bundle wrapper, arranged in a position coaxial to the interior of the pressure casing, delimits, with this pressure casing, an annular space.

Moreover, the tubes of the bundle are held in a uniform position in transverse planes perpendicular to the axis of the bundle by means of tube support plates which are distributed at uniform distances over the height of the bundle.

The tube support plates have passing through them a network of openings which is identical to the network of openings of the tube plate of the steam generator. The openings of the tube support plates are implemented such that the tubes are held efficiently within the openings, in order, during operation, to prevent vibrations of the tubes which may cause damage to the bundle. There must, however, remain sufficient play between the tubes and the bearing edges of the opening to ensure that the tubes of the bundle can be slid without difficulty through the tube support plates at the time when the bundle is mounted.

Furthermore, other openings in the tube support plates must allow circulation around the tubes of the feedwater of the steam generator which comes into contact with the outer surface of the tubes.

During the operation of the steam generator, the feedwater circulating in contact with the outer surface of the tubes of the bundle and inside the secondary cooling system of the reactor becomes laden with impurities of various types which may be deposited in the form of sludge in various parts of the steam generator, particularly on the tube plate and especially in the gaps formed between the tubes of the bundle and the openings of the tube support plates reserved for them in order to allow the cooling water to circulate around the tubes of the bundle.

The deposits which accumulate between the openings of the tube support plates and the outer surface of the tubes of the bundle may cause some embedding of the tubes in the opening, in such a way that the tubes are fastened rigidly in the tube support plate and can no longer move in the axial direction common to the openings and to the tubes and are also immobilized in the radial directions.

In some instances, the tubes may experience high corrosion in the region of the openings passing through the tube support plates, on account of the presence of the deposits, and may be deformed by necking in the region of the openings of the tube support plates due to the accumulation of the deposits.

In order to eliminate the sludge deposited on the tube plate of the steam generator, it has been proposed to carry out a cleaning of this tube plate, after a certain period of operation of the steam generator, by spraying water under pressure onto the upper surface of the tube plate by means of lances. One or more cleaning lances can be introduced into a free diametrically-directed central part of the steam generator, called a central water lane, or into the bundle itself, via an inspection or monitoring hole passing through the casing of the steam generator and the bundle wrapper in which the bundle is arranged.

To eliminate the sludge deposited in the gaps between the tubes and the openings of the tube support plates, it is known to employ a method for the chemical cleaning of the whole of the secondary cooling system of the steam generator by causing to circulate in the secondary cooling system, and in particular within the casing of the steam generator, a chemical solution which is not aggressive towards the elements of the steam generator and the composition of which is determined so as to dissolve and eliminate the sludge.

However, such a method has limited efficiency and is complex to put into practice.

So as to carry out efficient cleaning of the spaces between the rows of tubes perpendicular to the sheets of tubes of the bundle, one solution involves producing, in the region of each tube support plate, an outer orifice in the pressure casing and then an inner orifice in the bundle wrapper, the two orifices being in the same axis and having substantially the same diameter.

Subsequently, a lance is introduced through the orifices in the region of each tube support plate and projects water under pressure onto the upper surface of the corresponding tube support plate in order to eliminate the sludge.

After this cleaning has been carried out, the inner orifice formed in the bundle wrapper has to be shut off, which presents difficulties because this bundle wrapper is placed inside and concentrically to the pressure casing.

Another difficulty is that the inner orifice formed in the bundle wrapper has substantially the same diameter as the outer orifice formed in the pressure casing, which makes it no easier to introduce and install a device for shutting off this inner orifice.

Moreover, the shut-off device must be capable of being removed in order to carry out the inspection of the tubes or a new cleaning.

The object of the invention is to propose a device for shutting off an inner orifice of a bundle wrapper of a steam generator, which makes it possible to solve these problems.

The subject of the invention, therefore, is a device for shutting off an inner orifice of a bundle wrapper of a steam generator of a pressurized-water nuclear reactor, the said bundle wrapper being arranged concentrically within a pressure casing provided with an outer orifice coinciding with the axis of the inner orifice, and the said inner orifice having a diameter substantially equal to the outer orifice in the axis of the inner orifice, characterized in that it comprises a movable shaft comprising:
a pair of lower half-flanges,
   a pair of upper half-flanges which can be rotated by the said movable shaft through 180° C. between a low position facing the lower half-flanges, for introduction into the said orifices and a high position opposite the said lower half-flanges, and
   means for clamping the lower half-flanges, on the one hand, and the upper half-flanges, on the other hand, on the peripheries arranged on either side of the inner orifice, in order to shut off this inner orifice.

According to other characteristics of the invention:
the pair of lower half-flanges is arranged between the pair of upper half-flanges, each pair of half-flanges comprising, with respect to the bundle wrapper, a half-flange interior to and a half-flange exterior to the bundle wrapper,
the interior half-flange of the pair of upper half-flanges is integral in terms of rotation and of translation with the shaft, and the exterior half-flange of this pair is integral in terms of rotation and free in terms of translation with the said shaft,
the shaft comprises means for locking the lower half-flanges in terms of translation during introduction into the said orifices,
the means for locking in terms of translation are formed, for each lower half-flange, by a transverse notch formed on the outer surface of the shaft,
the clamping means comprise a nut displaceable in translation on the shaft by means of a thread formed on the outer surface of the said shaft, and
the mutually facing surface portions of the interior half-flanges and the mutually facing surface portions of the exterior half-flanges of the pairs of lower and upper half-flanges respectively comprise bearing surfaces and complementary interlocking means.

The subject of the invention is also a method for shutting off an inner orifice of a bundle wrapper of a steam generator of a pressurized-water nuclear reactor by means of a shut-off device, as mentioned above, characterized in that:
the shaft carrying the pair of lower half-flanges which is locked in terms of translation and the pair of upper half-flanges in the low position is introduced, the half-flanges being spaced from and parallel to one another,
the interior half-flanges of the two pairs of lower and upper half-flanges are placed inside the bundle wrapper, and the exterior half-flanges of the said pairs are placed exterior to this bundle wrapper,
the shaft is rotated substantially through 180° about its axis in order to release the pair of lower half-flanges in terms of translation and to the pair of upper half-flanges in the high position,
the shaft is displaced in order to bring it substantially into coincidence with the axis of the inner orifice, and
the nut is driven in rotation in order to displace this nut in translation on the shaft and clamp the lower half-flanges, on the one hand, and the upper half-flanges, on the other hand, on the peripheries arranged on either side of the inner orifice, in order to shut off the said inner orifice of the bundle wrapper.

A subject of the invention is also a tooling for installing or removing a shut-off device, as mentioned above, characterized in that it comprises:
means for supporting and driving in rotation the shaft carrying the pair of lower half-flanges and the pair of upper half-flanges,
means for the longitudinal guidance of the shaft,
means for driving the nut of the shaft in rotation, and
means for the vertical displacement of the shaft carrying the respectively lower and upper pairs of half-flanges between the low position for introduction into the inner orifice and the high position for clamping the lower half-flanges and the upper half-flanges on the peripheries arranged on either side of this inner orifice, in order to shut off the said inner orifice of the bundle wrapper.

According to other characteristics of the invention:
the supporting and driving means comprise a spindle comprising a screw for integration in terms of translation with the shaft and a bush for fitting on this shaft, in order to integrate in terms of rotation the spindle and the shaft arranged end to end along their longitudinal axis,
the means for the longitudinal guidance of the shaft are formed by a sleeve,
the means for driving the nut in rotation are formed by a bush for integration in terms of rotation with the said nut, the said bush being carried by the sleeve, and
the means for vertical displacement comprise an exterior ring mounted in the outer orifice of the pressure casing and comprising an orifice for the guidance of an interior ring mounted freely in rotation in the said exterior ring and comprising an orifice for the guidance of the sleeve mounted freely in rotation and in translation in the said interior ring, the orifices for the guidance of the exterior and interior rings respectively being parallel and offset according to an eccentric arrangement, and
the tooling comprises means for clinching the nut on the shaft.

The characteristics and advantages of the invention will become apparent from the following description given by way of example and made with reference to the accompanying drawings in which:

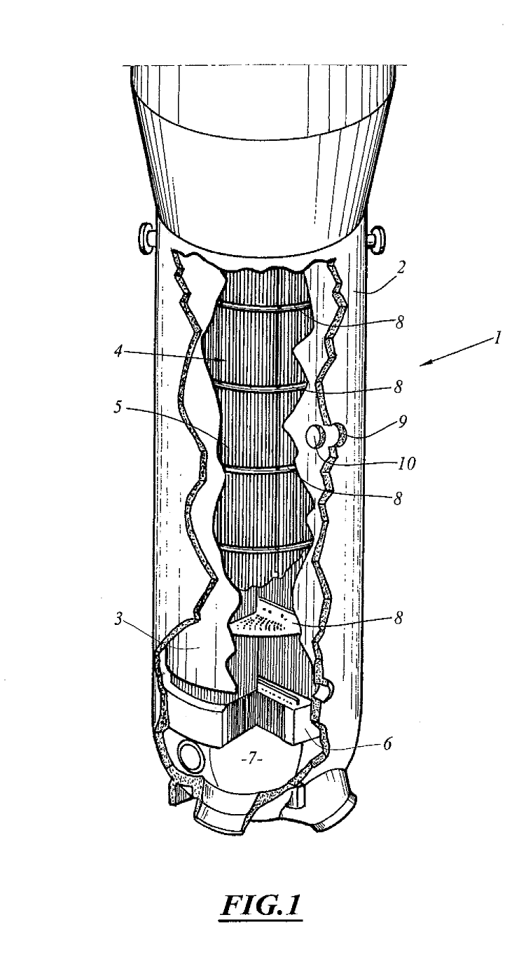

FIG. 1 is a diagrammatic perspective view of a steam generator of a pressurized-water nuclear reactor,

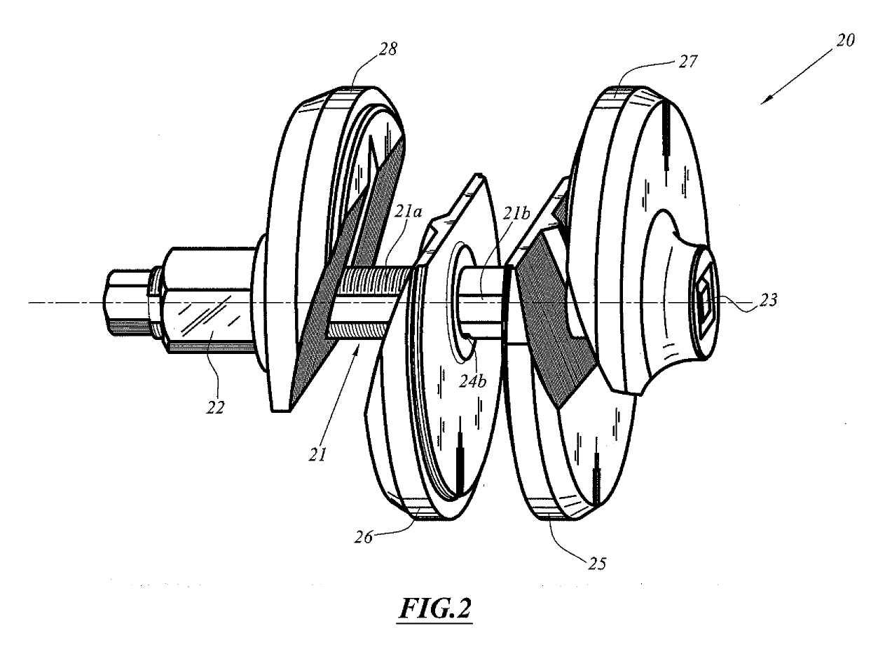

FIG. 2 is a diagrammatic perspective view of a shut-off device according to the invention, intended for closing an inner orifice of the bundle wrapper of the steam generator,

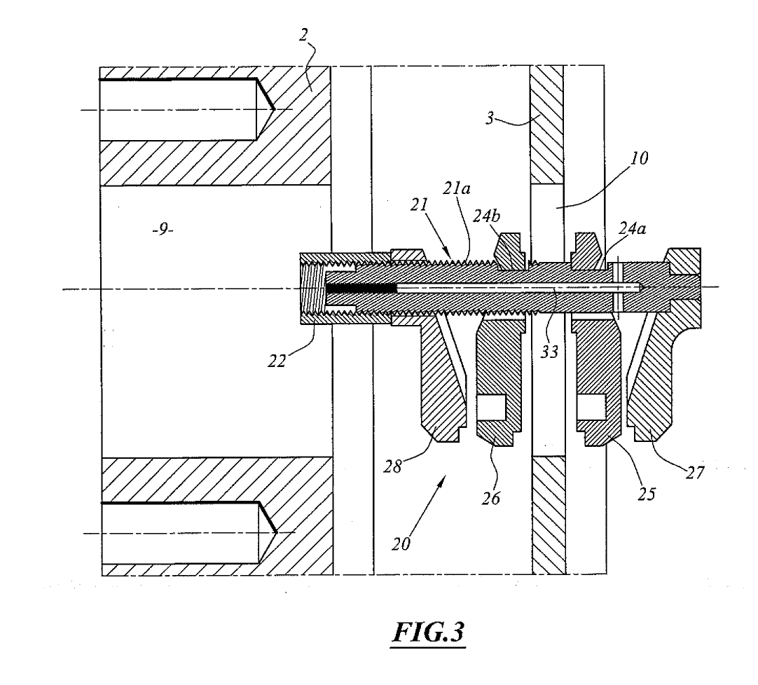

FIGS. 3 to 5 are diagrammatic views in axial section showing the various operating phases of the shut-off device according to the invention, and

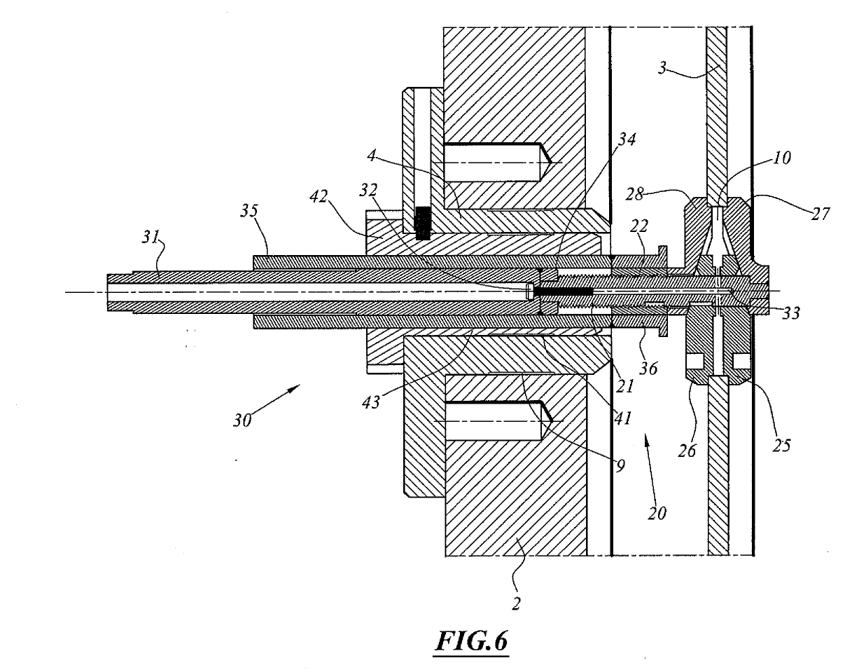

FIG. 6 is a diagrammatic view in axial section of a tooling for installing and removing the shut-off device.

FIG. 1 illustrates the lower part of a steam generator of a pressurized-water nuclear reactor, designated in general by the reference 1.

The steam generator 1 comprises, in a conventional way, a pressure casing 2 of substantially cylindrical shape, within which is arranged coaxially a bundle wrapper 3 containing a bundle of tubes 4 of the steam generator 1.

The tube bundle 4 consists of a very large number of tubes 5 bent in a U, each comprising two straight branches which are engaged and fastened at their end in a tube plate 6 fastened to the lower part of the pressure casing of the steam generator 1. The pressure casing 2 is connected to a hemispherical bottom delimiting a two-part water box 7.

Inside the bundle wrapper 3 are fastened, in successive positions over the height of the bundle, tube support plates 8 intended for holding the branches of the tubes 5 of the bundle 4, in order to prevent them from vibrating while the steam generator is in operation. Each of the tube support plates 8 is pierced with a network of opening similar to the array of openings passing through the tube plate 6 in which the ends of the tubes 5 of the bundle 4 are fastened. The straight branches of the tubes 5 of the bundle are engaged in aligned opening of tube support plates 8, spaced apart in the longitudinal direction of the tube 5.

Conventionally, the feedwater of the steam generator 1 is introduced into the pressure casing 2 so as to be capable of circulating from bottom to top, within the bundle wrapper 3, in contact with the outer surface of the tubes 5. The feedwater circulating in contact with the tubes is heated and then evaporates. The steam produced is recovered in the upper part of the steam generator so as to be delivered to the turbine of the nuclear reactor.

The feedwater recovered at the condenser of the turbine is returned to the steam generator and circulation of the feedwater is ensured by means of the secondary cooling system of the nuclear reactor.

The water circulating in the secondary cooling system and within the secondary part of the steam generator, in contact with the outer surface of the tubes 5 of the bundle 4, becomes laden with impurities, such as oxides, which may be deposited in the form of sludge on the upper surface of the tube plate 6 and also on the tube support plates 8, in particular in the gaps between the tubes 5 and the openings of these tube support plates 8 which must ensure these holding of the tubes 5 and the passage of the feedwater in contact with the outer surface of the said tubes 5.

During a shutdown of the nuclear reactor, after a certain period of operation of this reactor, it is necessary to carry out a cleaning of, in particular, the tube support plates 8, for example with the aid of a cleaning lance passing, on the one hand, through the pressure casing 2 and, on the other hand, through the bundle wrapper 3.

For this purpose, and as shown in FIG. 1, an orifice 9 in the pressure casing 2 and an orifice 10 in the bundle wrapper 3 are pierced with the aid of a suitable tooling, not illustrated, and substantially in the region of the tube support plate 8 to be cleaned. Hereafter, the orifice 9 will be called an outer orifice 9, and the orifice 10 will be called an inner orifice 10. These respectively inner 9 and outer 10 orifices are also designated commonly by the expression “inspection holes”. The inner orifice 10 is located in the axis of the outer orifice 9 and has a diameter substantially equal to or greater than this outer orifice 9.

After the cleaning of the tube support plate 8 has been carried out, the inner orifice 10 formed in the bundle wrapper 3 is closed with the aid of a shut-off device according to the invention, designated as a whole by the reference 20.

Referring now to FIGS. 2 and 3, the shut-off device 20 will be described.

This shut-off device 20 comprises a shaft 21 comprising on its outer surface a thread 21a and a nut 22 intended for cooperating with the thread 21a of the shaft 21.

The shut-off device 20 likewise comprises a pair of lower half-flanges 25 and 26 respectively and a pair of upper half-flanges 27 and 28 respectively. The pair of lower half-flanges 25 and 26 is arranged between the pair of upper half-flanges 27 and 28.

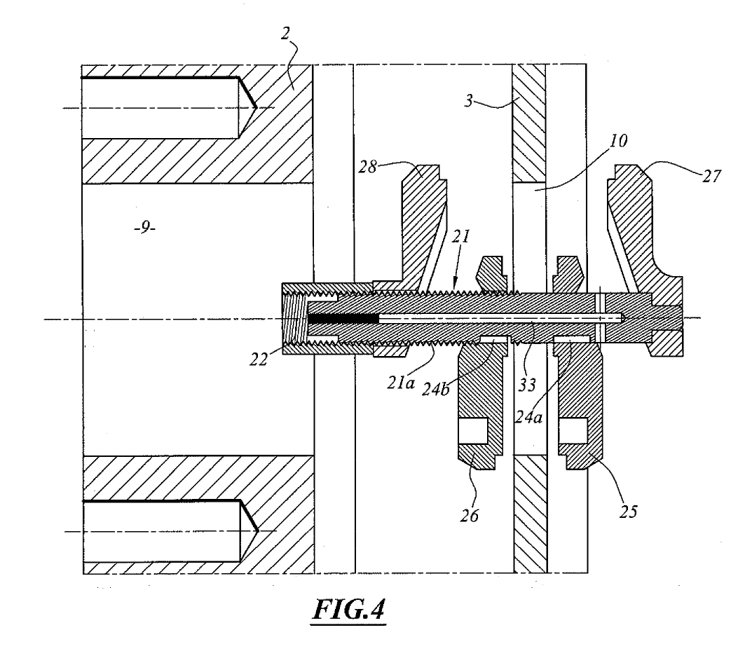

The two pairs of half-flanges, respectively lower 25 and 26 and upper 27 and 28, are displaceable by the rotation of the shaft 21 substantially through 180°, as will be seen later, between a low position for introduction into the orifices 9 and 10, as illustrated in FIG. 3, and in which the upper half-flanges 27 and 28 face the lower half-flanges 25 and 26, and a high position, illustrated in FIG. 4, for clamping, and in which the upper half-flanges 27 and 28 are opposite the lower half-flanges 25 and 26. In these positions, the half-flanges 25, 26, 27 and 28 are spaced apart from and parallel to one another.

Each pair of half-flanges comprises, with respect to the bundle wrapper 3, that is to say in the position corresponding to the clamping position illustrated in FIG. 4, a half-flange 25 and 27 interior to the said bundle wrapper 3 and a half-flange 26 and 28 exterior to the said bundle wrapper 3.

The interior half-flange 27 of the pair of upper half-flanges 27 and 28 is integral in terms of rotation and of translation with the shaft 21, for example by welding. For this purpose, the end of the shaft 21 comprises an element for holding the interior half-flange 27 in terms of rotation, the said element consisting, for example, of a square or a hexagon 23. The exterior half-flange 28 of this pair of half-flanges 27 and 28 is integral in terms of rotation and free in terms of translation with the shaft 21. For this purpose, this shaft 21 comprises two longitudinal and parallel flats 21b, as shown in FIG. 2.

Moreover, the shaft 21 comprises means for locking the lower half-flanges 25 and 26 in translation during introduction into the orifices 9 and 10. These locking means are formed, for the interior half-flange 25, by a transverse notch 24a made on the outer surface of the shaft 21 (FIGS. 3 and 4) and, for the exterior half-flange 26, likewise by a transverse notch 24b made on the outer surface of the said shaft 21 (FIGS. 3 and 4).

As can be seen in FIG. 2, the mutually facing surface portions of the interior half-flanges 25 and 27 and the mutually facing surface portions of the exterior half-flanges 26 and 28 of the pairs of lower half-flanges 25 and 26 and upper half-flanges 27 and 28 respectively comprise bearing surfaces and complementary interlocking means. These complementary interlocking means of the mortise-and-tenon type are formed, for example, by male/female Vs which ensure correct straightening and interlocking.

Referring now to FIGS. 3 to 5, the placing of the shut-off device 20 on the inner orifice 10 of the bundle wrapper 3 will be described.

First of all, and as shown in FIG. 3, the shut-off device is introduced into the outer orifice 9 and then into the inner orifice 10, with the upper half-flanges 27 and 28 in the low position, in which the half-flanges 25, 26, 27 and 28 are spaced apart from and parallel to one another. In this introduction position, the lower half-flanges 25 and 26 are locked in translation by the notches 24a and 24b respectively.

The interior half-flanges 25 and 27 of the two pairs of half-flanges, respectively lower 25 and 26 and upper 27 and 28, are placed inside the bundle wrapper 3, and the exterior half-flanges 26 and 28 of the two pairs of half-flanges, respectively lower 25 and 26 and upper 27 and 28, are placed outside this bundle wrapper 3, as shown in FIG. 3.

Subsequently, the shaft 21 is rotated substantially through 180° about its axis, the effect of this being to release the pair of lower half-flanges 25 and 26 in terms of translation on account of the rotation of the notches 24a and 24b, and the effect of this likewise being to place the pair of upper half-flanges 27 and 28 in the high position, as illustrated in FIG. 4.

The nut 22 is driven in rotation, and this nut 22, being displaced on the shaft 21, clamps the lower half-flanges 25 and 26, on the one hand, and the upper half-flanges 27 and 28, on the other hand, on the peripheries arranged on either side of the inner orifice 10, in order to shut off the said inner orifice of the bundle wrapper 3.

The half-flanges 25 and 27 and the half-flanges 26 and 28 are positioned with respect to one another by virtue of the bearing surfaces and of the complementary interlocking means.

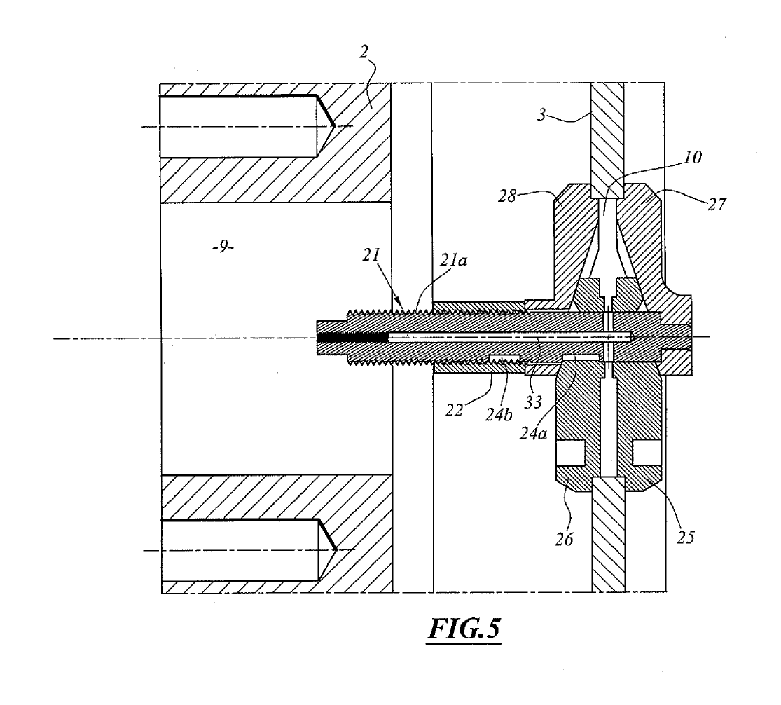

The bearing surfaces of the half-flanges 25 and 27 on the interior periphery of the inner orifice 10 and the bearing surfaces of the half-flanges 26 and 28 on the exterior periphery of the said inner orifice 10 match substantially the shape of the bundle wrapper 3, as shown in FIG. 5.

Between the nut 22 and the exterior half-flange 28, elastic washers, not illustrated, of the Belleville type may be inserted in order to ensure a gripping force on the bundle wrapper 3.

Once the shut-off device 20 is in place, correct mounting can be checked by measuring the dimension of the end of the shaft 21 in relation to the exterior of the pressure casing 2. This dimension is reliable, since it has low tolerance, and the least misalignment of two flanges, for example, may cause great disparity.

In order to prevent any unclamping, the nut 22 may be clinched on the shaft 21.

The installation and removal of the shut-off device 20 are carried out with the aid of a tooling, designated as a whole by the reference 30, which is illustrated in FIG. 6.

In general terms, the tooling comprises:
means for supporting and driving in rotation the shaft 21 carrying the pair of lower half-flanges 25 and 26 and the pair of upper half-flanges 27 and 28,
means for the longitudinal guidance of the shaft 21,
means for driving the nut 22 of the shaft 21 in rotation, and
means for the vertical displacement of the shaft 21 carrying the respectively lower 25 and 26 and upper 27 and 28 pairs of half-flanges between the low position for introduction into the inner orifice 10, as shown in FIG. 3, and the high position for clamping the lower half-flanges 25 and 26 and the upper half-flanges 27 and 28 on the peripheries arranged on either side of this inner orifice 10, in order to shut off the said inner orifice 10 of the bundle wrapper 3, as shown in FIGS. 5 and 6.

The means for supporting and driving in rotation the shaft 21 comprise a spindle 31 comprising axially a screw 32 for integration with the shaft 21. For this purpose, this shaft 21 comprises an axial bore 33, the inlet of which is threaded for screwing the screw 32. The supporting and driving means also comprise a bush 34 for fitting on the shaft 21, in order to integrate in terms of rotation the spindle 31 and the shaft 21 which are arranged end to end along their longitudinal axis.

The means for the longitudinal guidance of the shaft 21 are formed by a sleeve 35, within which are placed a spindle 31 and the shaft 21 integrated with one another.

The means for driving the nut 22 on the shaft 21 in rotation comprise a bush 36 for integration in terms of rotation with the said nut 22 and carried by the sleeve 35.

The means for the vertical displacement of the shaft 21 after the positioning of the interior half-flanges 25 and 27 and of the exterior half-flanges 26 and 28 on either side of the inner orifice 10 comprise an exterior ring 40 mounted in the outer orifice 9 and held on the pressure casing 2, for example by screwing members, not illustrated. This exterior ring 40 comprises an orifice 41 for the guidance of an interior ring 42 provided with an orifice 43 for guiding the sleeve 35.

The sleeve 35 is mounted freely in rotation and in translation in the orifice 43 of the interior ring 42, and the spindle 31 is likewise mounted freely in rotation and in translation in the said sleeve 35. The interior ring 42 is free only in rotation in the exterior ring 40.

The guide orifices 41 and 43 formed respectively in the exterior 40 and interior 42 rings are parallel and offset according to an eccentric arrangement.

The shut-off device 20 is put in place by means of the tooling 30 in the following way.

First of all, the shut-off device 20 is mounted on the tooling 30, the spindle 31 being integrated with the shaft 21 by means of the screw 32. The shaft 21 is integrated with the spindle 31 in terms of rotation by means of the bush 34. The bush 36 carried by the sleeve 35 is engaged on the nut 22 of the shaft 21.

The assembly consisting of the shut-off device 20 and of the tooling 30 is placed in the position for introduction into the outer orifice 9 of the pressure casing 2, and the interior ring 42 is locked on the exterior ring 40 by suitable means, not illustrated, in order to maintain the introduction position. This assembly thus assembled is introduced into the outer orifice 9 of the pressure casing 2, and the exterior ring 40 is locked on the said pressure casing 2.

The spindle 31 integral with the shaft 21 and the sleeve 35 are pushed into the interior ring 42 until a specific dimension is obtained between the face of the exterior ring 40 and the end of the spindle 31, in order to ensure the positioning of the interior half-flanges 25 and 27 and of the exterior half-flanges 26 and 28 on either side of the bundle wrapper 3. The two pairs of half-flanges, respectively lower 25 and 26 and upper 27 and 28, are in the introduction position illustrated in FIG. 3, in which the two lower half-flanges 25 and 26 are locked in translation on the shaft 21 by means of the notches 24a and 24b respectively.

In this introduction position, the axis of the shaft 21 is positioned above the axis of the orifices 9 and 10, since the guide orifices 41 and 43 are offset with respect to one another, thus allowing the passage of the half-flanges 25 and 27 into the bundle wrapper 3.

The interior ring 42 is rotated substantially through 180° in the exterior ring 40, thus aligning the shaft 21 and the outer orifice 9 of the pressure casing 2, in order to place the pairs of lower 25 and 26 and upper 27 and 28 half-flanges in the clamping position, as shown in FIG. 4.

The spindle 31 is drawn outwards, likewise driving the sleeve 35, in order to put the interior half-flanges 25 and 27 into contact with the inside of the bundle wrapper 3. These interior half-flanges 25 and 27 are interlocked one in the other. While the spindle 31 is held, the sleeve 35 is rotated, the effect of this being to screw the nut 22 by means of the bush 36, thus bringing towards one another the exterior half-flanges 26 and 28 which are interlocked one in the other. These exterior half-flanges 26 and 28 are laid progressively against the bundle wrapper 3, and the lower half-flanges 25 and 26 and the upper half-flanges 27 and 28 clamp the peripheries arranged on either side of the inner orifice 10 in order to shut off this inner orifice 10.

A clinching of the nut is carried out, for example by means of a deformable collar, not illustrated here, so as to immobilize it in terms of rotation and of translation and so as to hold the shut-off device in place.

Subsequently, with the spindle 31 being held, the screw 32 is unscrewed in order to release the shaft 21, and the tooling 30 as a whole is then removed from the outer orifice 9 of the pressure casing 2. The inner orifice 10 is thus shut off.

During the demounting of the shut-off device 20, the complete tooling 30 is not necessary, and the respectively exterior 40 and interior 42 rings are not necessarily used.

If, at the time of demounting, the shut-off device 20 remains jammed, several solutions may be envisaged, in particular the use of a nozzle for injecting water under pressure into the axial bore 33 of the shaft 21 which issues between the half-flanges 25, 26, 27 and 28, in order to loosen them.

In general terms, the device according to the invention may be employed in order to shut off an orifice of a containment.

1. Device for shutting off an inner orifice (10) of a bundle wrapper (3) of a steam generator (1) of a pressurized-water nuclear reactor, the said bundle wrapper (3) being arranged concentrically within a pressure casing (2) provided with an outer orifice (9) coinciding with the axis of the inner orifice (10), and the said inner orifice (10) having a diameter substantially equal to the outer orifice (9), characterized in that it comprises a movable shaft (21) comprising:
a pair of lower half-flanges (25, 26),
a pair of upper half-flanges (27, 28) which can be rotated by the said shaft (21) substantially through 180° between a low position facing the lower half-flanges (25, 26), for introduction into the said orifices (9, 10) and a high position opposite the said lower half-flanges (25, 26), and
means (22) for clamping the lower half-flanges (25, 26), on the one hand, and the upper half-flanges (27, 28), on the other hand, on the peripheries arranged on either side of the inner orifice (10), in order to shut off this inner orifice (10).

2. Device according to claim 1, characterized in that the pair of lower half-flanges (25, 26) is arranged between the pair of upper half-flanges (27, 28), each pair of half-flanges (25, 26; 27, 28) comprising, with respect to the bundle wrapper (3), a half-flange (25; 27) interior to and a half-flange (26; 28) exterior to the said bundle wrapper (3).

3. Device according to claim 2, characterized in that the interior half-flange (27) of the pair of upper half-flanges (27, 28) is integral in terms of rotation and of translation with the shaft (21), and the exterior half-flange (28) of this pair (27, 28) is integral in terms of rotation and free in terms of translation with the said shaft (21).

4. Device according to claim 1, characterized in that the shaft (21) comprises means (24a, 24b) for locking the lower half-flanges (25, 26) in terms of translation during introduction into the said orifices (9, 10).

5. Device according to claim 1, characterized in that the means for locking in terms of translation are formed, for each lower half-flange (25, 26), by a transverse notch (24a, 24b) formed on the outer surface of the shaft (21).

6. Device according to claim 1, characterized in that the clamping means comprise a nut (22) displaceable in translation on the shaft (21) by means of a thread (21b) formed on the outer surface of the said shaft (21).

7. Device according to claim 1, characterized in that the mutually facing surface portions of the interior half-flanges (25; 27) and the mutually facing surface portions of the exterior half-flanges (26; 28) of the pairs of lower (25, 26) and upper (27, 28) half-flanges respectively comprise bearing surfaces and complementary interlocking means.

8. Method for shutting off an inner orifice (10) of a bundle wrapper (3) of a steam generator (1) of a pressurized-water nuclear reactor by means of a shut-off device (20) according to claim 1, characterized in that:
the shaft (21) carrying the pair of lower half-flanges (25, 26) which is locked in terms of translation and the pair of upper half-flanges (27, 28) in the low position is introduced, the half-flanges (25, 26; 27, 28) being spaced from and parallel to one another,
the interior half-flanges (25; 27) of the two pairs of lower (25, 26) and upper (27, 28) half-flanges are placed inside the bundle wrapper (3), and the exterior half-flanges (26; 28) of the said pairs (25, 26; 27, 28) are placed exterior to this bundle wrapper (3),
the shaft (21) is rotated substantially through 180° about its axis in order to release the pair of lower half-flanges (25, 26) in terms of translation and to place the pair of upper half-flanges (27, 28) in the high position,
the shaft (21) is displaced in order to bring it substantially into coincidence with the axis of the inner orifice (10), and
the nut (22) is driven in rotation in order to displace this nut (22) in translation on the shaft (21) and clamp the lower half-flanges (25, 26), on the one hand, and the upper half-flanges (27, 28), on the other hand, on the peripheries arranged on either side of the inner orifice (10), in order to shut off the said inner orifice (10) of the bundle wrapper (3).

9. Tooling for installing or removing a shut-off device (20) according to claim 1, characterized in that it comprises:
means (31, 32, 34) for supporting and driving in rotation the shaft (21) carrying the pair of lower half-flanges (25, 26) and the pair of upper half-flanges (27, 28),
means (35) for the longitudinal guidance of the shaft (21),
means (36) for driving the nut (22) of the shaft (21) in rotation, and
means (40, 41, 42, 43) for the vertical displacement of the shaft (21) carrying the respectively lower (25, 26) and upper (27, 28) pairs of half-flanges between the low position for introduction into the inner orifice (10) and the high position for clamping the lower half-flanges (25, 26) and the upper half-flanges (27, 28) on the peripheries arranged on either side of this inner orifice (10), in order to shut off the said inner orifice (10) of the bundle wrapper (3).

10. Tooling according to claim 9, characterized in that the supporting and driving means comprise a spindle (31) comprising a screw (32) for integration in terms of translation with the shaft (21) and a bush (34) for fitting on this shaft (21), in order to integrate in terms of rotation the spindle (31) and the shaft (21) arranged end to end along their longitudinal axis.

11. Tooling according to claim 9, characterized in that the means for the longitudinal guidance of the shaft (21) are formed by a sleeve (35).

12. Tooling according to claim 9, characterized in that the means for driving the nut (22) in rotation are formed by a bush (36) for integration in terms of rotation with the said nut (22), the said bush being carried by the sleeve (35).

13. Tooling according to claim 9, characterized in that the means for vertical displacement comprise an exterior ring (40) mounted in the outer orifice (9) of the pressure casing (2) and comprising an orifice (41) for the guidance of an interior ring (42) mounted freely in rotation in the said exterior ring (40) and comprising an orifice (43) for the guidance of the sleeve (35) mounted freely in rotation and in translation in the said interior ring (42), the orifices (41, 43) for the guidance of the exterior (40) and interior (42) rings respectively being parallel and offset according to an eccentric arrangement.

14. Tooling according to claim 9, characterized in that it comprises means for clinching the nut (22) on the shaft (21).
